(19) United States
(12) Patent Application Publication
(10) Pub. No.: US 2013/0095043 A1
(43) Pub. Date: Apr. 18, 2013

(54) SYNTHESIS OF HIGH-PERFORMANCE IRON OXIDE PARTICLE TRACERS FOR MAGNETIC PARTICLE IMAGING (MPI)

(71) Applicants: Dirk Burdinski, Essen (DE); Carmen Bohlender, Jena (DE); Nicole P.M. Haex, Waalre (NL)

(72) Inventors: Dirk Burdinski, Essen (DE); Carmen Bohlender, Jena (DE); Nicole P.M. Haex, Waalre (NL)

(73) Assignee: KONINKLIJKE PHILIPS ELECTRONICS N.V., EINDHOVEN (NL)

(21) Appl. No.: 13/806,864

(22) PCT Filed: Jun. 21, 2011
(86) PCT No.: PCT/IB11/52712

§ 371 Date: Dec. 26, 2012

(30) Foreign Application Priority Data
Jun. 29, 2010 (EP) 10167693.0

(51) Int. Cl. A61J 3/00

(52) U.S. Cl. CPC A61J 3/00
USPC 424/9.323; 427/2.11

(57) ABSTRACT

The present invention relates to a method of forming iron oxide nanoparticles comprising the steps of (a) suspending iron oxide/hydroxide and oleic acid or a derivative thereof in a primary organic solvent; (b) increasing the temperature of the suspension by a defined rate up to a maximum of 340° C. to 500° C.; (c) aging the suspension at the maximum temperature of step (b) for about 0.5 to 6 h; (d) cooling the suspension; (e) adding a secondary organic solvent; (f) precipitating nanoparticles by adding a non-solvent and removing excess solvent; (g) dispersing said nanoparticles in said secondary organic solvent; (h) mixing the dispersion of step (g) with a solution of a polymer; and (i) optionally removing said secondary organic solvent. The present invention further relates to an iron oxide nanoparticle obtainable by the method, the additional modification, encapsulation and decoration of such nanoparticles, as well as the use of the nanoparticles as tracers for Magnetic Particle Imaging (MPI), Magnetic Particle Spectroscopy (MPS).

### FIELD OF THE INVENTION

The present invention relates to a method of forming iron oxide nanoparticles comprising the steps of (a) suspending iron oxide/hydroxide and oleic acid or a derivative thereof in a primary organic solvent; (b) increasing the temperature of the suspension by a defined rate up to a maximum of 340° C. to 500° C.; (c) aging the suspension at the maximum temperature of step (b) for about 0.5 to 6 h; (d) cooling the suspension; (e) adding a secondary organic solvent; (f) precipitating nanoparticles by adding a non-solvent and removing excess solvent; (g) dispersing said nanoparticles in said secondary organic solvent; (h) mixing the dispersion of step (g) with a solution of a polymer; and (i) optionally removing said secondary organic solvent. The present invention further relates to an iron oxide nanoparticle obtainable by the method, the additional modification, encapsulation and decoration of such nanoparticles, as well as the use of the nanoparticles as tracers for Magnetic Particle Imaging (MPI) or Magnetic Particle Spectroscopy (MPS).

### BACKGROUND OF THE INVENTION

Magnetic Particle Imaging (MPI) is a tomographic imaging technique which relies on the nonlinearity of the magnetization curves of magnetic nanoparticles and the fact that the particle magnetization saturates at some magnetic field strength. In a medical context MPI uses the magnetic properties of ferromagnetic nanoparticles injected into the body to measure the nanoparticle concentration, e.g. in the blood. Because a body contains no naturally occurring magnetic materials visible to MPI, there is no background signal, whereas in classical Magnetic Resonance Imaging (MRI) approaches the thresholds for in vitro and in vivo imaging are such that the background signal from the host tissue is a crucial limiting factor. After injection, the MPI nanoparticles appear as bright signals in the images, from which nanoparticle concentrations can be calculated. By combining high spatial resolution with short image acquisition times, MPI can capture dynamic concentration changes as the nanoparticles are swept along by the blood stream. This allows MPI scanners to perform a wide range of functional measurements in a single scan.

A spectrometric variant of MPI is Magnetic Particle Spectroscopy (MPS) which is a zero-dimensional magnetic particle imaging approach. MPS provides remagnetization signals without reconstructing images and accordingly is an efficient way of characterizing the absolute response of magnetic particles when they are exposed to an oscillating magnetic field. MPS is thus closely linked to MPI and particle properties measured by MPS are characteristic for the performance of these particles as tracers for MPI.

An important aspect of MPI is the provision of suitable magnetic material, i.e. of magnetic nanoparticle tracers which can effectively be detected. However, up to now, no dedicated MPI tracer material has become commercially available.

The suitability of the magnetic material is intimately linked to its remagnetization properties. The remagnetization of magnetic nanoparticle traces depends on a number of parameters, most importantly on the composition of the magnetic material itself, its volume and anisotropy, and its particle size distribution. Due to toxicological reasoning and the experience in Magnetic Resonance Imaging applications, superparamagnetic particles of iron oxide (SIPOs) appear to be a material of choice for the development of MPI tracers. Since the MPS signal intensity increases with the size of the iron oxide particles, a useful signal is only obtained with particles having a magnetic core of larger than ca. 15 nm.

Furthermore, the particles should be monodisperse and should possess a small magnetic anisotropy constant of <2 kJ/m³ to be able to follow the fast remagnetization with a frequency of about 25 kHz. Thus, an iron oxide nanoparticle to be effective in MPI has to show a very narrow size distribution, a very good shape control and the potential for easy upscaling. Furthermore, the particle should be water-soluble.

Methods for the production of SIPOs are known in the art. Among these, in general, four synthetic strategies can be distinguished: thermal decomposition methods, hydrothermal synthesis methods, co-precipitation methods and microemulsion techniques. For SIPOs to be usable in MPI thermal decomposition is the synthesis method of choice.

Thermal decomposition, in general, entails the decomposition of suitable precursor molecules in an organic solvent in the presence of stabilizers, coating agents, and further additives, such as reducing or oxidizing agents. Yu et al., Chemical Communications, 2004, 2306-2307 describes the synthesis of iron oxide nanocrystals with a narrow size distribution by the pyrolysis of iron oleate salts. However, the nanoparticles synthesized with methods described in the prior art show poor MPI or MPS performance. In particular, none of these methods has been shown to yield nanoparticles with an MPI or MPS performance better than that of the imaging reference particle Resovist®.

There is thus a need for a simple and effective synthesis protocol yielding water-soluble iron oxide nanoparticles with an MPI/MPS performance superior of that of Resovist®.

### SUMMARY OF THE INVENTION

The present invention addresses this need and provides means and methods which allow the synthesis of water-soluble iron oxide nanoparticles with superior MPI/MPS performance. The above objective is in particular accomplished by a method comprising the steps of:

(a) suspending iron oxide/hydroxide and oleic acid or a derivative thereof in a primary organic solvent;

(b) increasing the temperature of the suspension by a defined rate up to a maximum of 340° C. to 500° C.;

(c) aging the suspension at the maximum temperature of step (b) for about 0.5 to 6 h;

(d) cooling the suspension;

(e) adding a secondary organic solvent;

(f) precipitating nanoparticles by adding a non-solvent and removing excess solvent;

(g) dispersing said nanoparticles in said secondary organic solvent;

(h) mixing the dispersion of step (g) with a solution of a polymer; and

(i) optionally removing said secondary organic solvent.

This method provides the advantageous of being straight-forward and using simple, cheap and easy to use starting materials. The obtained iron oxide nanoparticles are stable in aqueous solutions and have a dramatically superior MPI performance compared to the commonly used Resovist® particles.

In a preferred embodiment of the present invention said iron oxide/hydroxide is iron(III) oxide/hydroxide, iron(II)/hydroxide or a mixture of iron(III) and iron(II) oxide/hydroxide.

In a further, preferred embodiment the derivative of oleic acid as mentioned above is ammonium oleate, lithium oleate, sodium oleate, potassium oleate, magnesium oleate, calcium oleate, aluminium oleate or iron oleate.

In a further, particularly preferred embodiment said ammonium oleate is an alkyl ammonium oleate having the formula R¹R²R³R⁴N⁺, wherein R¹, R², R³ and R⁴ is an alkyl, aryl or silyl group, or a hydrogen.

In yet another particularly preferred embodiment said alkyl ammonium oleate is tetramethylammonium oleate, tetraethylammonium oleate, tetrapropylammonium oleate, tetrabutylammonium oleate or benzylammonium oleate.

In a further preferred embodiment said primary organic solvent as mentioned herein above is an alkane solvent having the formula CₙH₂ₙ₊ₘ, with 15≦n≦30 and −2≦m≦2. Additionally or alternatively, said non-solvent as mentioned herein above is acetone, butanone, pentanone, isopropylmethylketon, diethylester, methylpropylether, methylisopropylether, ethylpropylether, or ethylisopropylether. Additionally or alternatively, said secondary organic solvent is pentane, isopentane, neopentane, hexane, heptane, dichloromethan, chloroform, tetrachloromethan or dichloroethane.

In yet another preferred embodiment said rate of the temperature increase of step (b) is between about 1° C. and 10° C. per minute.

In further embodiment of the invention said temperature maximum of step (b) is 340° C. to 400° C. Additionally or alternatively said temperature of the suspension in cooling step (d) is lowered to about 40° C. to 90° C.

In yet another preferred embodiment of the invention said aging of step (c) is carried out for about 1 to 5 h.

In another preferred embodiment of the present invention said solution of a polymer is an essentially aqueous buffer solution of a hydrophilic biocompatible copolymer comprising poly ethylene glycol (PEG) and/or poly propylene glycol (PPG), an essentially aqueous solution of an amphiphilic phospho lipid comprising poly ethylene glycol (PEG) or an essentially aqueous buffer solution of an amphiphilic block-copolymer.

In another preferred embodiment the method as mentioned herein above comprises instead of step (h) a step in which the dispersion of step (g) is mixed with a hydrophilic or amphiphilic stabilizer such as citric acid, tartaric acid, lactic acid, oxalic acid, and/or any salt thereof, a dextran, carboxydextran, a polyethylenoxide-based polymer or co-polymer, or any combination thereof.

In yet another preferred embodiment removing step (i) of the method as mentioned herein above is carried out by stirring the mixture in an essentially non-closed system thereby allowing evaporation of said secondary organic solvent until an aqueous solution of hydrophilic nanoparticles is obtained.

In another particularly preferred embodiment one or more of the additional steps

(j) purifying the nanoparticle or nanoparticle solution obtainable in step (i);

(k) treating the nanonparticle or nanoparticle solution obtainable in step (i) or (j) with an oxidizing or reducing agent;

(l) modifying the surface of the nanoparticle obtainable in step (i), (j) or (k) by removing, replacing or altering the polymer or stabilizer coating;

(m) encapsulating or clustering the nanoparticle obtainable in step (i) to (l) with a carrier such as a micelle, liposomes, polymersomes, a blood cell, a polymer capsule, a dendrimer, a polymer, or a hydrogel; and

(n) decorating the nanoparticle obtainable in step (i) to (m) with a targeting ligand, is performed.

In a further aspect the present invention relates to an iron oxide nanoparticle obtainable by a method as defined herein above.

In a further aspect the present invention relates to the use of an iron oxide nanoparticle as defined herein above or an iron oxide nanoparticle obtainable by a method as mentioned herein above, as a tracer for Magnetic Particle Imaging (MPI) or Magnetic Particle Spectroscopy (MPS).

### BRIEF DESCRIPTION OF THE DRAWINGS

FIG. 1 depicts the size distribution of solid milled FeO(OH) samples used as starting material in the thermal decomposition synthesis. In the upper portion a volume-weighted size distribution is shown, in the lower portion a number-weighted size distribution is shown.

FIG. 2 shows Magnetic Particle Spectroscopy (MPS) spectra of samples 1.1 and 1.2 (Example 1) and of sample 2.2 (Example 2) compared to that of Resovist®.

FIG. 3A to G shows the MPS results of samples A to G (Example 3), provided in hexane solution, compared to Resovist®. The MPS spectra of samples A to D, F and G were normalized to the iron content (see FIGS. 3A-D, 3F and 3G). The MPS spectrum of sample E was normalized to the 3^{rd} harmonic of the MPS curve (see FIG. 3E).

FIG. 4A to E shows transmission electron microscopy (TEM) images of dried-in samples A (see FIG. 4A), B (see FIG. 4B), and C (see FIGS. 4C, 4D and 4E). The images of FIGS. 4A, B, and C are regular transmission TEM images. The image of FIG. 4D is a high-resolution TEM image (HR-TEM). The image of FIG. 4E is a high-angle dark field image.

FIG. 5 shows XRD spectra of dried-in samples A, B, and C compared to an Fe₃O₄ standard sample (Ref.). The theoretical line patterns for magnetite (Fe₃O₄) and γ-Fe₂O₃ (hematite) are depicted as further reference. The composition of the iron oxide core of all samples was concluded to be of the Fe₃O₄ (magnetite) type.

FIG. 6 shows the VSM spectrum of sample C (in hexane solution).

FIG. 7 shows the constitutional formula of an oleate anion (oa⁻).

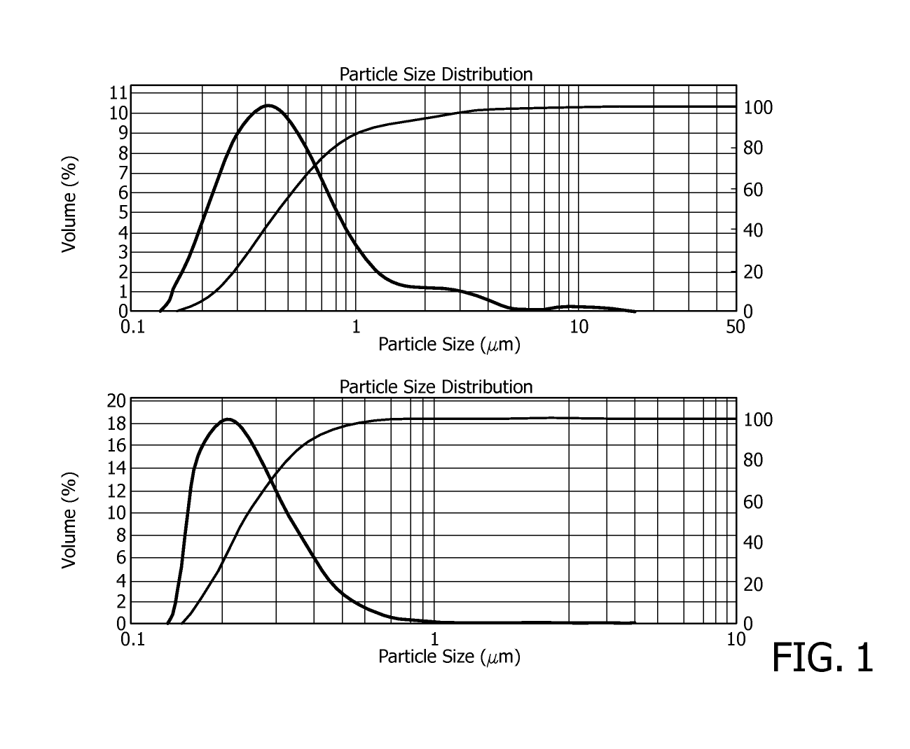

### DETAILED DESCRIPTION OF EMBODIMENTS

The inventors have developed means and methods which allow the synthesis of water-soluble iron oxide nanoparticles with superior MPI/MPS performance. These nanoparticles are suitable as MPI or MPS tracers.

Although the present invention will be described with respect to particular embodiments, this description is not to be construed in a limiting sense.

Before describing in detail exemplary embodiments of the present invention, definitions important for understanding the present invention are given.

As used in this specification and in the appended claims, the singular forms of “a” and “an” also include the respective plurals unless the context clearly dictates otherwise.

In the context of the present invention, the terms “about” and “approximately” denote an interval of accuracy that a person skilled in the art will understand to still ensure the technical effect of the feature in question. The term typically indicates a deviation from the indicated numerical value of ±20%, preferably ±15%, more preferably ±10%, and even more preferably ±5%.

It is to be understood that the term “comprising” is not limiting. For the purposes of the present invention the term “consisting of” is considered to be a preferred embodiment of the term “comprising of”. If hereinafter a group is defined to comprise at least a certain number of embodiments, this is meant to also encompass a group which preferably consists of these embodiments only.

Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

In case the terms “first”, “second”, “third” or “(a)”, “(b)”, “(c)”, “(d)” etc. relate to steps of a method or use there is no time or time interval coherence between the steps, i.e. the steps may be carried out simultaneously or there may be time intervals of seconds, minutes, hours, days, weeks, months or even years between such steps, unless otherwise indicated in the application as set forth herein above or below.

It is to be understood that this invention is not limited to the particular methodology, protocols, reagents etc. described herein as these may vary. It is also to be understood that the terminology used herein is for the purpose of describing particular embodiments only, and is not intended to limit the scope of the present invention that will be limited only by the appended claims. Unless defined otherwise, all technical and scientific terms used herein have the same meanings as commonly understood by one of ordinary skill in the art.

As has been set out above, the present invention concerns in one aspect a method of forming iron oxide nanoparticles comprising the steps of:

(a) suspending iron oxide/hydroxide and oleic acid or a derivative thereof in a primary organic solvent;

(b) increasing the temperature of the suspension by a defined rate up to a maximum of 340° C. to 500° C.;

(c) aging the suspension at the maximum temperature of step (b) for about 0.5 to 6 h;

(d) cooling the suspension;

(e) adding a secondary organic solvent;

(f) precipitating nanoparticles by adding a non-solvent and removing excess solvent;

(g) dispersing said nanoparticles in said secondary organic solvent;

(h) mixing the dispersion of step (g) with a solution of a polymer; and

(i) optionally removing said secondary organic solvent.

The initial step of the synthesis comprises suspending of iron oxide/hydroxide and oleic acid or a derivative thereof in a primary organic solvent. The term “primary organic solvent” as used herein refers to an organic solvent which is suitable for higher temperature boiling reactions. Preferably the primary organic solvent is an alkane. More preferably said alkane is a saturated alkane, even more preferably a linear saturated alkane. The solvent may be used alone or in a mixture with a different solvent, e.g. a mixture of two alkanes may be used as solvents. Preferred is the use of pure solvents, e.g. alkane solvents, since they allow for a better temperature control.

In a preferred embodiment of the present invention the primary organic solvent is an alkan solvent having the formula CₙH₂ₙ₊ₘ, with 15≦n≦30, and −2≦m≦2, preferably with 18≦n≦22, and 0≦m≦2, more preferably with n=20 and m=2. Examples of these solvents to be used are octadecene, tricosane, and paraffin wax. Particularly preferred is icosane as primary organic solvent.

In a specific embodiment of the present invention the primary organic solvent to be used may be chosen according to the temperature of nanoparticle synthesis step (b). For example the boiling point of icosane is about 343° C.; icosane may therefore preferably be used for reactions at a temperature of about 340° C. Alternatively higher alkane solvents with the indicated boiling points (in parentheses) may be used, preferably at higher temperatures, more preferably at temperatures at about the indicated boiling points: henicosane (357° C.), docosane (366° C.), tricosane (380° C.), tetracosane (391° C.), pentacosane (402° C.), hexacosane (412° C.), heptacosane (422° C.), octacosane (432° C.), nonacosane (441° C.), triacosane (450° C.), hentriacontane (458° C.), dotriacontane (467° C.), tritriacontane (475° C.), tetratriacontane (483° C.), pentatriacontane (490° C.), hexatriacontane (497° C.). Furthermore, any combination or sub-grouping of two or more of these solvents may be used.

Alternatively, the pressure conditions of the reaction may be adjusted, e.g. the pressure may be increased, allowing the employment of primary organic solvents as mentioned herein at temperatures above the indicated boiling points.

The term “iron oxide/hydroxide” as used herein refers to an iron oxide in different oxidation states, e.g. in the 0, +2, +3 or +4 oxidation state, preferably in the +2 or +3 oxidation state, or an iron hydroxide in different oxidation states, e.g. in the 0, +2, +3 qor +4 oxidation state, preferably in the +2 or +3 oxidation state. Preferably, the term relates to an. iron(II) oxide, an iron(III) oxide, an iron(II) iron(III) oxide, an iron(II) hydroxide, an iron(III) hydroxide, an iron(II) iron(III) hydroxide, an iron(II) oxide hydroxide, an iron (III) oxide hydroxide etc., or any hydrate thereof, or any combination thereof.

In a preferred embodiment of the present invention said iron oxide/hydroxide is iron (III) oxide/hydroxide, iron (II) oxide/hydroxide or a mixture of iron (III) and iron (II) oxide/hydroxide.

The oleic acid to be used may be an oleic acid, e.g. as depicted in FIG. 7, or a derivative thereof. Preferred are oleic acid derivatives which are at elevated temperatures at least partially soluble in the used solvent.

In a preferred embodiment of the present invention said oleic acid derivative may be ammonium oleate, lithium oleate, sodium oleate, potassium oleate, magnesium oleate, calcium oleate, aluminium oleate or iron oleate or any derivative or mixture thereof.

In a further, particularly preferred embodiment of the present invention said ammonium oleate may be an alkyl ammonium oleate having the formula R¹R²R³R⁴N⁺, wherein R¹, R², R³, R⁴ is an alkyl, aryl, or silyl groups or a hydrogen. R¹, R², R³, R⁴ may be identical or independently different. Furthermore, R¹ and R² may be identical or independently different, R³ and R⁴ may be identical or independently different, R¹ and R³ may be identical or independently different, or R¹ and R⁴ may be identical or independently different, R¹ and R³ may be identical or independently different, R² and R³ may be identical or independently different or R² and R⁴ may be identical or independently different.

In a further, particularly preferred embodiment of the present invention said ammonium oleate may be tetramethylammonium oleate, tetraethylammonium oleate, tetrapropylammonium oleate, tetrabutylammonium oleate, or benzylammonium oleate, or any derivative or mixture thereof.

In a further embodiment a combination of oleylamine and the oleic acid, or a derivative thereof as defined herein above, is suspended in a primary organic solvent as defined herein. Alternatively, a combination of oleylamine and the iron oxide/hydroxide as defined herein above, or a combination of oleylamine and the iron oxide/hydroxide as defined herein above and the oleic acid, or a derivative thereof as defined herein above may be suspended in a primary organic solvent as defined herein.

The amount of solvent for the suspension step may be adjusted to the amount of ingredients to be suspended. For example, an amount of solvent of once, twice, 3 times, 4 times, 5 times, 6 times, 7 times, 8 times, 9 times, 10 times, 15 times, 20 times, 30 times, 50 times, or 100 times the volume or weight of the ingredients to be dissolved may be used.

The suspension step may be carried out according to any suitable technique, e.g. by stirring the ingredients in the solvent, shaking of the reaction mixture, rotating movements etc. The suspension step may be performed until the iron oxide/hydroxide and/or oleic acid or derivative thereof are entirely suspended, e.g. until no iron oxide/hydroxide precipitate is optically detectable. The suspension step may be carried out, for example, for 1 min, 2 min, 5 min, 10 min, 20 min, 30 min, 45 min or 60 min, 2 h, 3 h, 4 h, 5 h, 6 h, 7 h, 8 h, 9 h, 10 h, 11 h, 12 h, 13 h, 14 h, 15 h, 16 h, 17 h, 18 h, 19 h, 20 h, 21 h, 22 h, 23 h or 24 h or any period of time in between these values.

The suspension step may be carried out at any suitable temperature, preferably at about 35° C. to 65° C., e.g. at about 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C. or 65° C. The temperature may further be lowered to about 25° C. or increased to about 75° C. During the suspension step the temperature may be kept constant, e.g. at any of the above indicated levels, or may be varied. For instance, the temperature may first be set to a lower level, e.g. about 35° C., and subsequently be increased, e.g. up to about 50° C., 55° C., 60° C. or 65° C. Alternatively, the temperature may first be set to a higher level, e.g. to about 50° C., 55° C., 60° C., or 65° C., and subsequently be decreased, e.g. down to 35° C., 40° C. or 45° C. Furthermore, temperature profiles of combined increases and decreases in various sequences may be used, e.g. first a decrease, followed by an increase and finally a decrease etc.

In a particular embodiment of the present invention iron oxide/hydroxide as mentioned above and the oleic acid or a derivative thereof may be used in specific molar or mass ratio. For example, a molar ratio of about 1:2, 1:3, 1:4, 1:5, 1:6, 1:7, 1:8, 1:9, 1:10, 1:11, 1:12, 1:13, 1:14, 1:15, 1:16, 1:17, 1:18, 1:19 or 1:20 of iron oxide/hydroxide:oleic acid may be employed. In a particularly preferred embodiment a mass ratio of 1:4, 1:8 or 1:12 of iron oxide/hydroxide:oleic acid may be employed.

In a further step of the synthesis the temperature of the suspension may be increased to a maximum of 340° C. to 500° C. In a preferred embodiment of the present invention the temperature of the suspension may be increased to a maximum of 340° C. to 400° C. The maximum temperature may, for example, be 340° C., 341° C., 342° C., 343° C., 344° C., 345° C., 350° C., 360° C., 370° C., 380° C., 390° C., 400° C., 410° C., 420° C., 430° C., 440° C., 450° C., 460° C., 470° C., 480° C., 490° C. or 500° C. Also higher temperatures above 500° C. are envisaged by the present invention.

In a particularly preferred embodiment, said maximum temperature may be chosen in accordance with the boiling point of the used primary organic solvent, e.g. for icosane about 340-343° C., for henicosane about 357° C., for docosane about 366° C., for tricosane about 380° C., for tetracosane about 391° C., for pentacosane about 402° C., for hexacosane about 412° C., for heptacosane about 422° C., for octacosane about 432° C., for nonacosane about 441° C., for triacosane about 450° C., for hentriacontane about 458° C., for dotriacontane about 467° C., for tritriacontane about 475° C., for tetratriacontane about 483° C., for pentatriacontane about 490° C., or for hexatriacontane about 497° C.

The temperature increase may preferably be accomplished by augmenting the temperature at a defined rate. In a preferred embodiment of the present invention the rate of the temperature increase of step (b) may between about 1° C. and 10° C. per minute. Alternatively, the rate of the temperature increase of step (b) may be between about 1° C. and 10° C. per 2 minutes, per 3 minutes or per 5 minutes. For instance, the temperature may be augmented at a rate of 1° C., 2° C., 2.5° C., 3° C., 3.5° C., 4° C., 4.5° C., 5° C., 6° C., 7° C., 8° C., 9° C. or 10° C. per minute, per 2 minutes, per 3 minutes or per 5 minutes. Preferably, the temperature may be increased by a rate of 3.3° C. per minute.

In a further step of the synthesis the suspension of step (b) is aged or boiled at the maximum temperature of step (b) for about 0.5 to 6 h. In a particularly preferred embodiment of the present invention said aging or boiling step may be carried out for about 1 h to 5 h. The aging or boiling may, for example, be carried out for 0.5 h, 0.75 h, 1 h, 1.5 h, 2 h, 2.5 h, 3 h, 3.5 h, 4 h, 4.5 h, 5 h, 5.5 h or 6 h. Furthermore, longer aging/boiling periods of >6 h are also envisaged by the present invention. During the aging/boiling step of the synthesis the temperature may preferably be kept at the maximum temperature of the previous step, e.g. at 340° C. Alternatively, the temperature may be varied within the range of maximum temperatures of 340° C. to 500° C. In a further embodiment, the temperature may also be lowered to values of about 200° C., 250° C., 300° C., 310° C., 320° or 330° C. Such temperature modifications may be performed once or more than one time, reverting after each modification to the maximum temperature as used in step (b). The modifications of the temperature, i.e. the periods of increased or decreased temperatures in comparison to the maximum temperature of step (b), may be short, e.g. in the range of 10 to 20 min, or prolonged, e.g. more than 30 min, more than 1 h, 2 hs, 3 h, 4 h. The period may depend on the period of the aging step.

In a further step of the synthesis the suspension of step (c) is cooled. The cooling may be carried out by using suitable cooling equipment, or by a transfer to a suitably cooled environment. In a preferred embodiment of the present invention the suspension is cooled to a temperature of about 40° C. to 90° C., more preferably to a temperature of about 50° C. to 80° C. The reaction mixture may, for example, be cooled to a temperature of about 40° C., 45° C., 50° C., 55° C., 60° C., 65° C., 70° C., 75° C., 80° C., 85° C., or 90° C.

The cooling may be performed by an immediate temperature change, e.g. to any of the above indicated temperatures. Alternatively, the cooling may be carried out gradually, e.g. by decreasing the temperature of the reaction mixture of step (d) by 1, 2, 3, 4, 5, 6, 7, 8, 9, 10, 15 or 20° C. per minute, per 2 minutes, per 5 minutes, per 10 minutes or per 20 minutes.

In a further step of the synthesis to the suspension of step (d) a secondary organic solvent is added. The term “secondary organic solvent” as used herein refers to an organic solvent which is suitable for lower temperature reactions, e.g. reactions in a temperature range of 40° C. to 90° C. or range of 40° C. to 80° C. Preferably said secondary organic solvent has a lower boiling point than the primary organic solvent, e.g. at a range of 20° C. to 90° C., and/or a lower viscosity. Secondary organic solvents may preferably be short-chain alkanes.

In a particularly preferred embodiment of the present invention said secondary organic solvents to be used in the context of this synthesis step are pentane, isopentane, neopentane, hexane, heptane, dichloromethane, choroform, tetrachloromethane or dichloroethane. Particularly preferred is the use of pentane or hexane. The secondary organic solvent may be used alone or in a mixture with a different solvent, e.g. a mixture of two short chain alkanes may be used as solvents. Preferred is the use of pure solvents.

In a further step of the synthesis a non-solvent is added to the reaction mixture of step (e), leading to the precipitation of nanoparticles. The term “non-solvent” as used herein means an organic compound with a low boiling point that does not essentially dissolve the reaction product, i.e. the nanoparticles formed in the thermal decomposition step.

In a particularly preferred embodiment of the present invention said non-solvent is acetone, butanone, 2-butanone, pentanone, 2-pentanone, isopropyl methyl keton, diethylester, isobutyl methyl ketone, methylpropylether, methylisopropylether, ethylpropylether, ethylisopropylethertetrahydrofurane, diethylether or diisopropylether. The addition of the non-solvent may be carried out, in a specific embodiment, by agitating the reaction mixture, e.g. by a method of agitation as defined herein above. The amount or volume of non-solvent for the addition may be adjusted to the amount or volume of product of step (f).

The precipitation may be enhanced by centrifugation, e.g. for a period of 10 min to 60 min. The centrifugation may be performed at any suitable velocity, e.g. a 3,000 to 10,000 rpm, preferably at about 4900 rpm.

Subsequently, excess solvent or supernatant may be discarded. Precipitated nanoparticles may be obtained and kept for the next synthesis step.

In a further step of the synthesis the nanoparticles obtained in step (f) are dissolved in a secondary organic solvent as defined herein above. As secondary organic solvent either the same solvent used for step (e) may be used, or a different solvent may be employed. Preferably, pentane or hexane may be used. The amount of solvent for the dispersion step may be adjusted to the amount of precipitated product of step (f). For example, an amount of secondary organic solvent of once, twice, 3 times, 4 times, 5 times, 6 times, 7 times, 8 times, 9 times, 10 times, 15 times, 20 times, 30 times, 50 times, or 100 times the volume or weight of the product of step (f) may be used. The mixing may be performed for any suitable period of time, e.g. for about 30 min to 24 h, preferably for about 45 min to 18 h, more preferably for about 1 h to 14 h.

The precipitation and subsequent dispersion of nanoparticles may be carried out only one time or be repeated once, twice, 3 times, 4 times, 5 times, 6 times or more often. A repetition of these steps is supposed to help increasing the purity of the nanoparticles.

In a particular embodiment of the present invention, nanoparticles synthesized in accordance with the above described steps may be dispersed or dissolved in a defined volume of secondary organic solvent, preferably in hexane, e.g. in a volume of 10 ml of hexane. Accordingly dispersed nanoparticles may subsequently be used for analytical approaches, e.g. experiments and analyses as described in the Examples, or for alternative synthesis or modification steps.

Accordingly obtained nanoparticles may be present in a monodisperse form, or be present in a polydisperse form. The term “monodisperse” as used herein refers to a narrow nanoparticle size distribution. Monodisperse nanoparticles according to the present invention may have a size which differs only by 0.1 to 3 nm from the average size of a larger group of nanoparticles, e.g. a group of 1,000, 10,000 or 50,000 nanoparticles obtained according to the presently described method. “Polydisperse” forms may have a size which differs by more than 3 nm from the average size of a larger group of nanoparticles, e.g. a group of 1,000, 10,000 or 50,000 nanoparticles obtained according to the presently described method. Such nanoparticles may be present in distinct size groups, each being monodisperse, or may be present in statistical or broader size distribution.

Monodisperse nanoparticles may either be employed directly for additional synthesis steps or be combined with different size groups. Polydisperse nanoparticles may either be used directly or alternatively be subjected to a size fractionation or separation procedure in order to obtain monodisperse nanoparticles, or in order to reduce the polydisperse character of the nanoparticle group. For example, a size fractionation or separation may be carried out according to approaches or based on the use of apparatuses or systems as described in WO 2008/099346 or WO 2009/057022. Alternatively or additionally a fractionation or separation according to the particle form may be carried out.

In yet another step of the synthesis the dispersion of step (g) or any derived, fractioned, separated or otherwise modified mixture of nanoparticles according to the present invention is mixed with a solution of a polymer.

In a preferred embodiment of the present invention said solution of a polymer may be an essentially aqueous buffer solution of a hydrophilic biocompatible copolymer comprising poly ethylene glycol (PEG) and/or poly propylene glycol (PPG).

In a further, preferred embodiment of the present invention said solution of a polymer may be an essentially aqueous solution of an amphiphilic phospholipid comprising PEG.

In yet another, preferred embodiment of the present invention said solution of a polymer may be an essentially aqueous buffer solution of an amphiphilic block-copolymer.

The term “essentially aqueous” as used herein refers to the presence of at least 51% to 99.999% of H₂O molecules in the solution or buffer.

Particularly preferred is the employment of a poly(ethylene glycol)-block-poly(propylene glycol)-block-poly(ethylene gycol) (PEG-PPG-PEG), e.g. Pluronic. Even more preferred is the use of Pluronic F68, Pluronic F108 or Pluronic F127. Most preferred is the use of PluronicF127

Further, suitable polymers to be used in this synthesis step are amphiphilic PEGylated phospholipids or lipids. A preferred example of these phospholipids is DSPE-PEGx-Y, in which Y═OH, OCH₃, OCH₂CH₃, x=200-5000, or DSPE=1,2-distearoyl-sn-glycero-3-phosphoethanolamine. A preferred example of a lipid is 1,2-distearoyl-sn-glycero-3-phosphoethanolamine-N-[methoxy(polyethylene glycol)-2000] (ammonium salt) (DSPE-PEG2000(OMe)).

The amount of polymer solution for the mixing step may be adjusted to the amount of precipitated product of step (f) or the volume of step (g). For example, an amount of polymer solution of once, twice, 3 times, 4 times, 5 times, 6 times, 7 times, 8 times, 9 times, 10 times, 15 times, 20 times, 30 times the volume of the reaction mixture of step (g) may be used. The mixing may be performed for any suitable period of time, e.g. for about 5 min to 24 h, preferably for about 45 min to 18 h, more preferably for about 1 h to 14 h.

In a preferred embodiment the mixing step may be carried out by stirring the two-phase mixture, e.g. in an essentially non-closed system.

In a further preferred embodiment of the present invention the dispersion of step (g) may alternatively be mixed with a hydrophilic or amphiphilic stabilizer. Preferred examples of such a stabilizer are citric acid, tartaric acid, lactic acid, oxalic acid, and/or any salt thereof, a dextran, carboxydextran, a polyethylenoxide-based polymer or co-polymer, or any combination thereof. The amount of stabilizer for the mixing step may be adjusted to the amount of precipitated product of step (f) or the volume of step (g). For example, an amount of stabilizer of once, twice, 3 times, 4 times, 5 times, 6 times, 7 times, 8 times, 9 times, 10 times, 15 times, 20 times, 30 times the volume of the reaction mixture of step (g) may be used. The mixing may be performed for any suitable period of time, e.g. for about 5 min to 5 days, preferably for about 45 min to 48 h, more preferably for about 1 h to 24 h.

In a preferred embodiment the mixing step may be carried out by stirring the two-phase mixture, e.g. in an essentially non-closed system.

In a final, optional step of the synthesis in the solution of nanoparticles obtained in the previous step, either by mixing with a polymer solution, or by mixing with a hydrophilic or amphiphilic stabilizer, said secondary organic solvent may be removed. This removal may be performed by letting the secondary organic solvent evaporate, preferably during the mixing procedure of step (h). Accordingly, the evaporation step may be performed by increasing the surface of the reaction mixture, e.g. by employing suitable reaction vessels or by agitating the reaction mixture. Additionally or alternatively, the gaseous space or areal in contact with the liquid reaction mixture may be altered by ventilation or gas exchange step in order to reduce the concentration of volatiles in said space or areal.

In a particularly preferred embodiment of the present invention said removing step is carried out by stirring the mixture in an essentially non-closed system thereby allowing evaporation of said secondary organic solvent until an aequeous solution of hydrophilic nanoparticles is obtained.

The synthesis results thus in an aqueous solution of hydrophilic nanoparticles.

Accordingly obtained nanoparticles may be present in a monodisperse form, or be present in a polydisperse form as defined herein above, e.g. in dependence on the performance of any separation or fraction step carried out during the synthesis procedure as mentioned above. Accordingly, monodisperse nanoparticles may either be employed directly or be combined with different size groups. Polydisperse nanoparticles may also either be used directly or alternatively be subjected to a size fractionation or separation procedure in order to obtain monodisperse nanoparticles, or in order to reduce the polydisperse character of the nanoparticle group, as described herein above.

In a further embodiment of the present invention said nanoparticles or solution of nanoparticles as obtained according to the above defined steps or variants thereof may further be treated, modified or varied according to the additional method steps of:

(j) purifying the nanoparticle or nanoparticle solution obtainable in the step (i);

(k) treating the nanoparticle or nanoparticle solution obtainable in step (i) or (j) with an oxidizing or reducing agent;

(l) modifying the surface of the nanoparticle obtainable in step (i), (j) or (k) by removing, replacing or altering the coating;

(m) encapsulating or clustering the nanoparticle obtainable in step (i) to (l) with a carrier such as a micelle, a liposome, a polymersome, a blood cell, a polymer capsule, a dendrimer, a polymer, or a hydrogel; and

(n) decorating the nanoparticle obtainable in step (i) to (m) with a targeting ligand.

The purification of the nanoparticle or nanoparticle solution obtainable in the step (i) or any variant thereof may be carried out by, e.g. filtrating the solution. The filtration may be carried out according to any suitable method, e.g. by employing dynamic filtration like microfiltration, ultrafiltration, nanofiltration, reverse osmosis, or by using static filtration such as vacuum filtration, pressure filtration or membrane filtration etc. Furthermore, molecular sieves may be employed.

In another, optional step the nanoparticle or nanoparticle solution obtainable in step (i) or (j) or any variant thereof may be treated with an oxidizing or reducing agent. Examples of these agents are trimethylamine-N-oxide, pyridine-N-oxide, ferrocenium hexafluorophosphate and ferrocenium tetrafluorborate. Preferred is the employment of trimethylamine-N-oxide.

Furthermore, the surface of the nanoparticle obtainable in step (i), (j) or (k) or any variant thereof may be modified by removing, replacing or altering the coating. Such modifications may be carried out according to suitable chemical reactions known the person skilled in the art, e.g. reactions as mentioned in F. Herranz et al., Chemistry—A European Journal, 2008, 14, 9126-9130; F. Herranz et al. Contrast Media & Molecular Imaging, 2008, 3, 215-222; J. Liu et al. Journal of the American Chemical Society, 2009, 131, 1354-1355; W. J. M. Mulder et al., NMR in Biomedicine, 2006, 19, 142-164; or E. V. Shtykova et al, Journal of Physical Chemistry C, 2008, 112, 16809-16817.

In another, optional, additional or alternative step the nanoparticle obtainable in step (i) to (l) or any variant thereof may be encapsulated in or clustered with a carrier. Preferably, a carrier structure comprising or composed of one or more suitable amphipathic molecules a such as lipids, phospho lipids, hydrocarbon-based surfactants, cholesterol, glycolipids, bile acids, saponins, fatty acids, synthetic amphipathic block copolymers or natural products like egg yolk phospholipids etc. may be used. Particularly preferred are phospholipids and synthetic block copolymers. Particularly preferred examples of suitable carriers are a micelle, a liposome, a polymersome, a blood cell, a polymer capsule, a dendrimer, a polymer, or a hydrogel or any mixtures thereof.

The term “micelle” as used herein refers to a vesicle type which is also typically made of lipids, in particular phosopholipids, which are organized in a monolayer structure. Micelles typically comprise a hydrophobic interior or cavity.

The term “liposome” as used herein refers to a vesicle type which is typically made of lipids, in particular phospholipids, i.e. molecules forming a membrane like structure with a bilayer in aqueous environment. Preferred phospholipids to be used in the context of liposomes include phosphatidylethanolamine, phosphatidylcho line, egg phosphatidylethanolamine, dioleoylphosphatidylethanolamine. Particularly preferred are the phospholipids MPPC, DPPC, DPPE-PEG2000 or Liss Rhod PE.

The term “polymersome” as used herein means a vesicle-type which is typically composed of block copolymer amphiphiles, i.e. synthetic amphiphiles that have an amphiphilicity similar to that of lipids. By virtue of their amphiphilic nature (having a more hydrophilic head and a more hydrophobic tail), the block copolymers are capable of self-assembly into a head-to-tail and tail-to-head bilayer structure similar to liposomes. Compared to liposomes, polymersomes have much larger molecular weights, with number average molecular weights typically ranging from 1000 to 100,000, preferably of from 2500 to 50,000 and more preferably from 5000 to 25000, are typically chemically more stable, less leaky, less prone to interfere with biological membranes, and less dynamic due to a lower critical aggregation concentration. These properties result in less opsonisation and longer circulation times.

The term “dendrimer” as used herein means a large, synthetically produced polymer in which the atoms are arranged in an array of branches and sub-branches radiating out from a central core. The synthesis and use of dendrimers is known to a person of skill in the art.

The term “hydrogel” as used herein means a colloidal gel in which water is the dispersion medium. Hydrogels exhibit no flow in the steady-state due to a three-dimensional crosslinked network within the gel. Hydrogels can be formed from natural or synthetic polymers. The obtainment and use of hydrogels is known to a person of skill in the art.

In another, optional, additional or alternative step the nanoparticle obtainable in step (i) to (m) or any variant thereof may be decorated with a targeting ligand.

The term “targeting ligand” as used herein refers to a targeting entity, which allows an interaction and/or recognition of the decorated nanoparticle by compatible elements, or stabilizing or destabilizing elements, which modify the chemical, physical and/or biological properties of the nanoparticle. These elements are typically present at the outside or outer surface of the nanoparticle. Particularly preferred are elements which allow a targeting of the nanoparticle to specific tissue types, specific organs, cells or cell types or specific parts of the body, in particular the animal or human body. For example, the presence of target ligands may lead to a targeting of the nanoparticle to organs like liver, kidney, lungs, heart, pancreas, gall, spleen, lymphatic structures, skin, brain, muscles etc. Alternatively, the presence of targeting ligands may lead to a targeting to specific cell types, e.g. cancerous cells which express an interacting or recognizable protein at the surface. In a preferred embodiment of the present invention the nanoparticle may comprise proteins or peptides or fragments thereof, which offer an interaction surface at the outside of the nanoparticle. Examples of such protein or peptide elements are ligands which are capable of binding to receptor molecules, receptor molecules, which are capable of interacting with ligands or other receptors, antibodies or antibody fragments or derivatives thereof, which are capable of interacting with their antigens, or avidin, streptavidin, neutravidin, lectins. Also envisaged by the present invention is the presence of binding interactors like biotin, which may, for example be present in the form of biotinylated compounds like proteins or peptides etc. The nanoparticle may also comprise vitamins or antigens capable of interacting with compatible integrators, e.g. vitamin binding protein or antibodies etc.

In another aspect the present invention relates to an iron oxide nanoparticle which is obtainable or obtained by any method or method variant as defined herein above. The iron oxid nanoparticle may be in any suitable form, state or condition, e.g. it may be provided as solid iron oxid nanoparticle, as dissolved iron oxide nanoparticle, e.g. dissolved in any suitable solvent or buffer, Furthermore, the iron oxide nanoparticle may be provided in a monodisperse form or in a polydisperse form as defined herein above.

In yet another aspect the present invention relates to the use an iron oxide nanoparticle as defined herein above or an iron oxide nanoparticle obtainable or obtained by any method or method variant as defined herein above, as a tracer for Magnetic Particle Imaging (MPI) or Magnetic Particle Spectroscopy (MPS), or for a combination of MPI and MPS, e.g. as contrast agent. In a further, particular embodiment of the present invention said iron oxide nanoparticle may also be used for classical magnetic resonance imaging (MRI), e.g. as contrast agent.

Accordingly, an iron oxide nanoparticle obtainable or obtained by any method or method variant as defined herein above may be employed in methods of diagnosis or treatment of a disease or pathological condition, or as ingredient of a diagnostic or pharmaceutical composition, e.g. for the treatment or diagnosis of a diseases or pathological conditions, in particular a disease, disorder, tissue or organ malfunction etc., which is targetable by a nanoparticle as defined herein above.

For example, a pathological condition may be targetable if the diseased area or zone or the zone of malfunction is connected to the cardiovascular system. Alternatively, a pathological condition may be targetable if the diseased area or zone or the zone of malfunction is connected to the lymphatic system. In a further alternative, a pathological condition may be targetable if the diseased area or zone or the zone of malfunction is connected to the cerebrospinal fluid system. Further pathological conditions which may be targeted, i.e. diagnosed or treated with a nanoparticle according to the present invention include, but are not limited to deficiencies or disorders of the immune system, e.g. the proliferation, differentiation, or mobilization (chemotaxis) of immune cells. Also included are deficiencies or disorders of hematopoictic cells. Examples of immunologic deficiency syndromes include blood protein disorders (e.g. agammaglobulinemia, dysgammaglobulinemia), ataxia telangiectasia, common variable immunodeficiency, Digeorge Syndrome, thrombocytopenia, or hemoglobinuria. Further included are cardiovascular diseases, disorders, and conditions and/or cardiovascular abnormalities, such as arterio-arterial fistula, arteriovenous fistula, cerebral arteriovenous malformations, congenital heart defects, pulmonary atresia, and Scimitar Syndrome. Congenital heart defects include aortic coarctation, cor triatriatum, coronary vessel anomalies, crisscross heart, dextrocardia, patent ductus arteriosus, Ebstein's anomaly, Eisenmenger complex, hypoplastic left heart syndrome, levocardia, tetralogy of fallot, transposition of great vessels, double outlet right ventricle, tricuspid atresia, persistent truncus arteriosus, and heart septal defects, such as aortopulmonary septal defect, endocardial cushion defects, Lutembacher's Syndrome, trilogy of Fallot, ventricular heart septal defects. Cardiovascular diseases, disorders, and/or conditions also include heart disease, such as arrhythmias, carcinoid heart disease, high cardiac output, low cardiac output, cardiac tamponade, endocarditis (including bacterial), heart aneurysm, cardiac arrest, congestive heart failure, congestive cardiomyopathy, paroxysmal dyspnea, cardiac edema, heart hypertrophy, congestive cardiomyopathy, left ventricular hypertrophy, right ventricular hypertrophy, post-infarction heart rupture, ventricular septal rupture, heart valve diseases, myocardial diseases, myocardial ischemia, pericardial effusion, pericarditis, pneumopericardium, postpericardiotomy syndrome, pulmonary heart disease, rheumatic heart disease, ventricular dysfunction, hyperemia, cardiovascular pregnancy complications, Scimitar Syndrome, cardiovascular syphilis, and cardiovascular tuberculosis. Arrhythmias include sinus arrhythmia, atrial fibrillation, atrial flutter, bradycardia, extrasystole, Adams-Stokes Syndrome, bundle-branch block, sinoatrial block, long QT syndrome, parasystole, Lown-Ganong-Levine Syndrome, Mahaimtype pre-excitation syndrome, Wolff-Parkinson-White syndrome, sick sinus syndrome, tachycardias, and ventricular fibrillation. Tachycardias include paroxysmal tachycardia, supraventricular tachycardia, accelerated idioventricular rhythm, atrioventricular nodal reentry tachycardia, ectopic atrial tachycardia, ectopic junctional tachycardia, sinoatrial nodal reentry tachycardia, sinus tachycardia, Torsades de Pointes, and ventricular tachycardia. Heart valve disease include aortic valve insufficiency, aortic valve stenosis, hear murmurs, aortic valve prolapse, mitral valve prolapse, tricuspid valve prolapse, mitral valve insufficiency, mitral valve stenosis, pulmonary atresia, pulmonary valve insufficiency, pulmonary valve stenosis, tricuspid atresia, tricuspid valve insufficiency, and tricuspid valve stenosis. Myocardial diseases include alcoholic cardiomyopathy, hypertrophic cardiomyopathy, aortic subvalvular stenosis, pulmonary subvalvular stenosis, restrictive cardiomyopathy, Chagas cardiomyopathy, endocardial fibroelastosis, endomyocardial fibrosis, Kearns Syndrome, myocardial reperfusion injury, and myocarditis. Myocardial ischemias include coronary disease, such as angina pectoris, coronary aneurysm, coronary arteriosclerosis, coronary thrombosis, coronary vasospasm, myocardial infarction and myocardial stunning Cardiovascular diseases also include vascular diseases such as aneurysms, angiodysplasia, angiomatosis, bacillary angiomatosis, Hippel-Lindau Disease, Klippel-Trenaunay-Weber Syndrome, Sturge-Weber Syndrome, angioneurotic edema, aortic diseases, Takayasu's Arteritis, aortitis, Leriche's Syndrome, arterial occlusive diseases, arteritis, enarteritis, polyarteritis nodosa, cerebrovascular diseases, disorders, and/or conditions, diabetic angiopathies, diabetic retinopathy, embolisms, thrombosis, erythromelalgia, hemorrhoids, hepatic veno-occlusive disease, hypertension, hypotension, ischemia, peripheral vascular diseases, phlebitis, pulmonary venoocclusive disease, Raynaud's disease, CREST syndrome, retinal vein occlusion, Scimitar syndrome, superior vena cava syndrome, telangiectasia, atacia telangiectasia, hereditary hemorrhagic telangiectasia, varicocele, varicose veins, varicose ulcer, vasculitis, and venous insufficiency. Aneurysms include dissecting aneurysms, false aneurysms, infected aneurysms, ruptured aneurysms, aortic aneurysms, cerebral aneurysms, coronary aneurysms, heart aneurysms, and iliac aneurysms. Arterial occlusive diseases include arteriosclerosis, intermittent claudication, carotid stenosis, fibromuscular dysplasias, mesenteric vascular occlusion, Moyamoya disease, renal artery obstruction, retinal artery occlusion, and thromboangiitis obliterans. Cerebrovascular diseases, disorders, and/or conditions include carotid artery diseases, cerebral amyloid angiopathy, cerebral aneurysm, cerebral anoxia, cerebral arteriosclerosis, cerebral arteriovenous malformation, cerebral artery diseases, cerebral embolism and thrombosis, carotid artery thrombosis, sinus thrombosis, Wallenberg's syndrome, cerebral hemorrhage, epidural hematoma, subdural hematoma, subaraxhnoid hemorrhage, cerebral infarction, cerebral ischemia (including transient), subclavian steal syndrome, periventricular leukomalacia, vascular headache, cluster headache, migraine, and vertebrobasilar insufficiency. Further included are autoimmune disorders such as Addison's Disease, hemolytic anemia, antiphospho lipid syndrome, rheumatoid arthritis, dermatitis, allergic encephalomyelitis, glomerulonephritis, Goodpasture's-Syndrome, Graves Disease, Multiple Sclerosis, Myasthenia Gravis, Neuritis, Ophthalmia, Bullous Pemphigoid, Pemphigus, Polyendocrinopathies, Purpura, Reiter's Disease, Stiff-Man Syndrome, Autoimmune Thyroiditis, Systemic Lupus Erythematosus, Autoimmune Pulmonary Inflammation, Guillain-Barre Syndrome, insulin dependent diabetes mellitis, or autoimmune inflammatory eye disease. Additionally included are allergic reactions and conditions, such as asthma (particularly allergic asthma) or other respiratory problems; as well as hyperproliferative disorders, including neoplasms, cancers or tumors, such as neoplasms, cancers or tumors located in the: abdomen, bone, breast, digestive system, liver, pancreas, peritoneum, endocrine glands (adrenal, parathyroid, pituitary, testicles, ovary, thymus, thyroid), eye, head and neck, nervous (central and peripheral), lymphatic system, pelvic, skin, soft tissue, spleen, thoracic, and urogenital tract. Further examples of hyperproliferative disorders are hypergammaglobulinemia, lymphoproliferative disorders, paraproteinemi as, purpura, sarcoidosis, Sezary Syndrome, Waldenstron's Macroglobulinermia, Gaucher's Disease, histiocytosis, and any other hyperproliferative disease, located in an organ system listed above. Further included are neurodegenerative disease states, behavioral disorders, or inflammatory conditions which include Alzheimer's Disease, Parkinson's Disease, Huntington's Disease, encephalitis, demyelinating diseases, peripheral neuropathies, trauma, congenital malformations, spinal cord injuries, ischemia, aneurysms or hemorrhages.

In a further embodiment of the present invention an iron oxide nanoparticle obtainable or obtained by any method or method variant as defined herein above may be used for transport purposes, e.g. in combination with a drug. For example, such a drug may be released at a specified position within the human or animal body.

The following examples and figures are provided for illustrative purposes. It is thus understood that the example and figures are not to be construed as limiting. The skilled person in the art will clearly be able to envisage further modifications of the principles laid out herein.

### EXAMPLES

### Example 1

In a first synthesis block FeO(OH) (200 mg, 2.25 mmol), oleic acid (HOA) (2.54 g, 9.0 mmol) and icosane (1.2 g) were placed in a 3-necked flask (50 ml). The flask was placed in a heating mantle and equipped with a stirrer, a thermo sensor, which was connected to a thermo couple, and a reflux condenser including a bubble gauge. The thermocouple was set to 360° C. with a heating rate of 3.3° C./min for 2 hours. During decomposition the color of the reaction mixture changed from red-brown to black indicting the formation of iron oxide nanoparticles. The flask was allowed to cool to 50° C. Hexane (10 ml) was added and the mixture was placed in a centrifuge flask. The nanoparticles were precipitated form the hexane solution by adding acetone (20 ml). The flask was centrifuged for 30 min at 4900 rpm (4671 rcf). The black supernatant was decanted, the remaining nanoparticles were re-dispersed in hexane (5 ml) and precipitated with acetone (10 ml). This washing procedure was repeated once. The resulting purified nanoparticles were re-dispersed and stored in 10 ml hexane (the obtained sample was designated sample 1.1).

In a second synthesis block 10 ml of the nanoparticle solution obtained in the first synthesis block was diluted with 10 ml of hexane (solution A). Pluronic F127 (1.09 g) was dissolved in phosphate-buffered saline (PBS, 20 ml) (solution B). Solution A (1.5 ml) and solution B (1.5 ml) were mixed and stirred in an open beaker and the solvents were allowed to evaporate. After 43 hours a homogeneous, black aqueous PBS solution was obtained; essentially all of the hexane had evaporated. This solution was stable for at least four weeks as no precipitate was observed (the obtained sample was designated sample 1.2).

The total iron concentration of the obtained buffer solutions was determined in a Prussian Blue-based colorimetric assay analysis to be 3.33 mg(Fe)/g.

### Example 2

In a first synthesis block FeO(OH) (200 mg, 2.25 mmol), oleic acid (HOA) (2.54 g, 9.0 mmol) and icosane (1.2 g) were placed in a 3-necked flask (50 ml). The flask was placed in a heating mantle and equipped with a stirrer, a thermo sensor, which was connected to a thermo couple, and a reflux condenser including a bubble gauge. The thermocouple was set to 360° C. with a heating rate of 3.3° C./min for 2 hours. During decomposition the color of the reaction mixture changed from red-brown to black indicting the formation of iron oxide nanoparticles. The flask was allowed to cool to 50° C. Hexane (10 ml) was added and the mixture was placed in a centrifuge flask. The nanoparticles were precipitated form the hexane solution by adding acetone (20 ml). The flask was centrifuged for 30 min at 4900 rpm (4671 rcf). The black supernatant was decanted, the remaining nanoparticles were re-dispersed in hexane (5 ml) and precipitated with acetone (10 ml). This washing procedure was repeated once. The resulting purified nanoparticles were re-dispersed and stored in 10 ml hexane (the obtained sample was designated sample 1.1).

In a second synthesis block 10 ml of the nanoparticle solution obtained in the first synthesis block was diluted with 10 ml of hexane (solution A). Pluronic F127 (0.31 g) was dissolved in phosphate-buffered saline (PBS, 20 ml) (solution B). Solution A (1.5 ml) and solution B (1.5 ml) were mixed and stirred in an open beaker and the solvents were allowed to evaporate. After 43 hours a homogenous, black aqueous PBS solution was obtained; essentially all of the hexane had evaporated. This solution was stable for at least several weeks as no precipitate was observed (the obtained sample was designated sample 2.2).

The total iron concentration of the obtained buffer solutions was determined in a Prussian Blue-based colorimetric assay analysis to be 2.53 mg(Fe)/g.

### Example 3

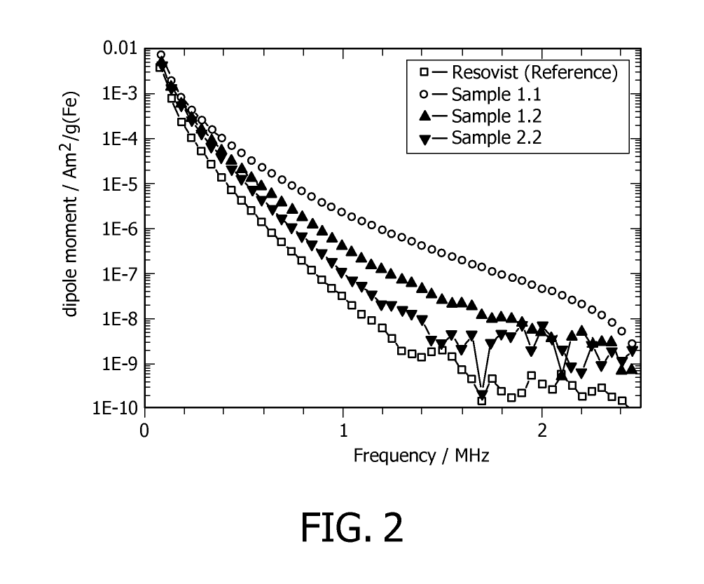

The performance of the obtained samples was tested in Magnetic Particle Spectroscopy (MPS) analyses. The MPS performance of sample 1.1 was at 1 MHz two orders of magnitude better than that of Resovist® and the superiority even increased at higher frequencies (see FIG. 2). Sample 2.1 and 2.2 were both up to 1 order of magnitude better than Resovist® at 1 MHz and the superiority also increased at higher frequencies (see FIG. 2). The difference in MPS performance in hexane and in water is not yet fully understood and may be a result of the chemical modification necessary to hydrophilize the nanoparticles.

### Example 4

In a first synthesis block FeO(OH), oleic acid (HOA) and icosane (1.2 g) were placed in a3-necked flask (50 ml). Details of the used amounts of FeO(OH) and oleic acid and the stoichiometry of the components are provided in Table 1, infra The flask was placed in a heating mantle and equipped with a stirrer, a thermo sensor, which was connected to a thermo couple, and a reflux condenser including a bubble gauge. The thermocouple was set to 360° C. with a heating rate of 3.3° C./min for 2 hours. During decomposition the color of the reaction mixture changed from red-brown to black indicting the formation of iron oxide nanoparticles. The flask was allowed to cool to 50° C. Hexane (10 ml) was added and the mixture was placed in a centrifuge flask. The nanoparticles were precipitated form the hexane solution by adding acetone (20 ml). The flask was centrifuged for 30 min at 4900 rpm (4671 rcf). The black supernatant was decanted, the remaining nanoparticles were re-dispersed in hexane (5 ml) and precipitated with acetone (10 ml). This washing procedure was repeated once. The resulting purified nanoparticles were re-dispersed and stored in 10 ml hexane (the obtained samples were designated samples A to H).

The performance of the obtained samples was tested in Magnetic Particle Spectroscopy (MPS) analyses. All analyses of the samples were performed using these hexane solutions.

TABLE 1
Composition of the reaction mixture in the different experiments of
Example 4 leading to the generation of samples A to H.

| | | | Stoichiometry | |
|---|---|---|---|---|
| | m(FeO(OH))/ | | (mol/mol) | Reaction |
| Sample | mg | m (HOA)/g | (FeO(OH):HOA) | time/h |
| A | 200 | 2.54 | 1:4 | 2 |
| B | 200 | 5.08 | 1:8 | 2 |
| C | 100 | 3.81 | 1:12 | 2 |
| D | 100 | 5.08 | 1:16 | 2 |
| E | 300 | 3.81 | 1:4 | 2 |
| F | 50 | 2.543 | 1:16 | 2 |
| G | 50 | 1.91 | 1:12 | 2 |

### Variation of the Reaction Conditions:

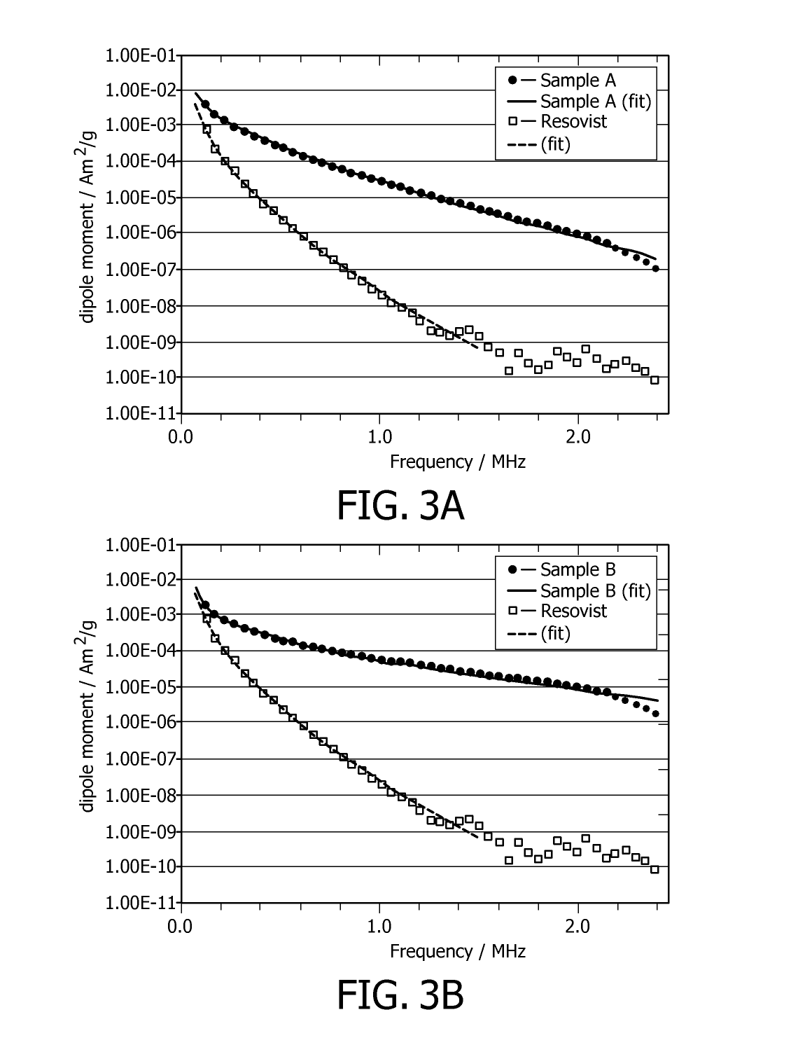

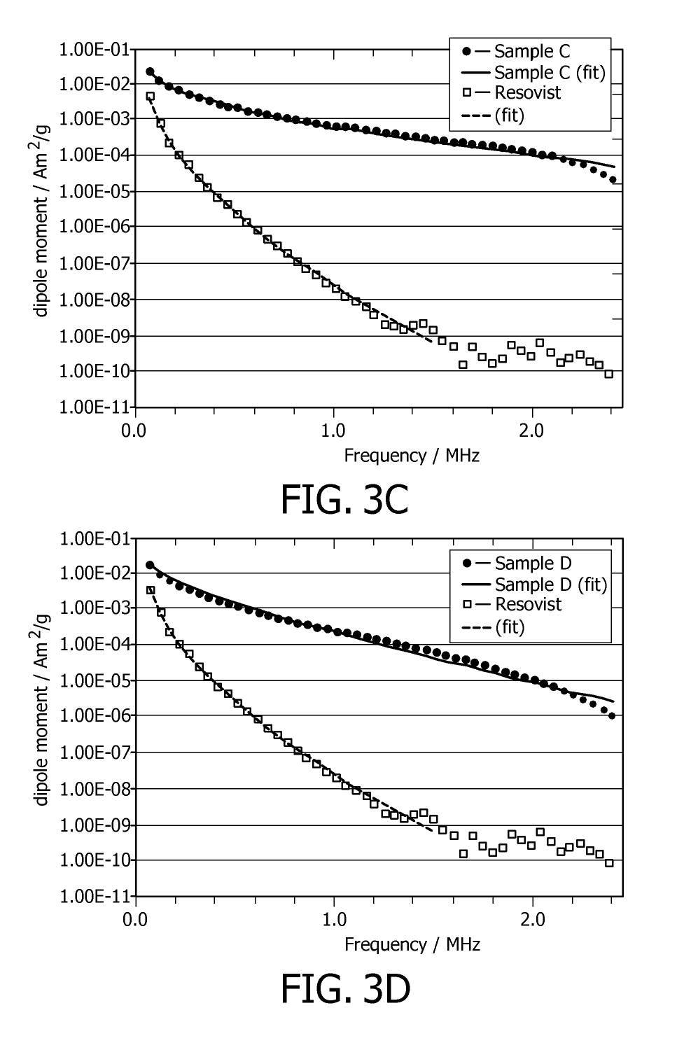

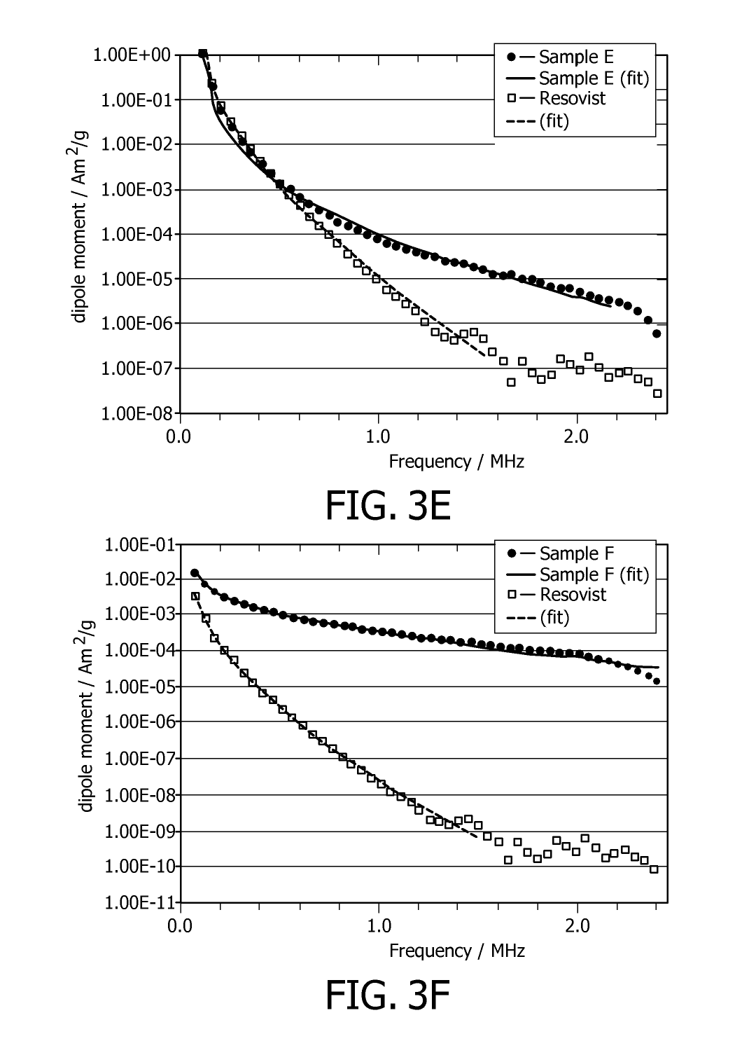

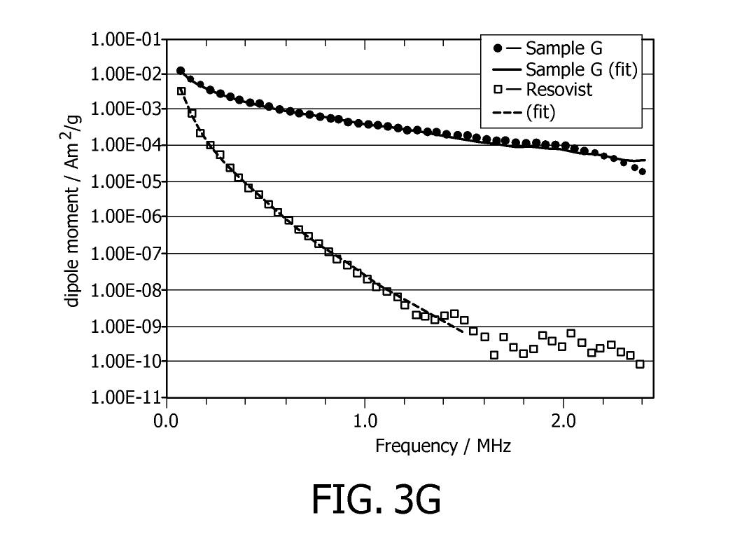

Samples A, B, C and F showed an increase of the MPS signal at higher frequencies when the FeO(OH):HOA ratio was raised, as can be derived from FIGS. 3A, B, C and F. Samples D, E, and G illustrate that in addition to the relative concentration of FeO(OH) and HOA, also their absolute concentration is important, for which an optimum range is described by samples A, B, C and F. In addition sample G indicates the importance of the reaction time. Under the here described conditions running the reaction for 2 h yielded better results than running the reaction for 6 h.

### Transmission Electron Microscopy:

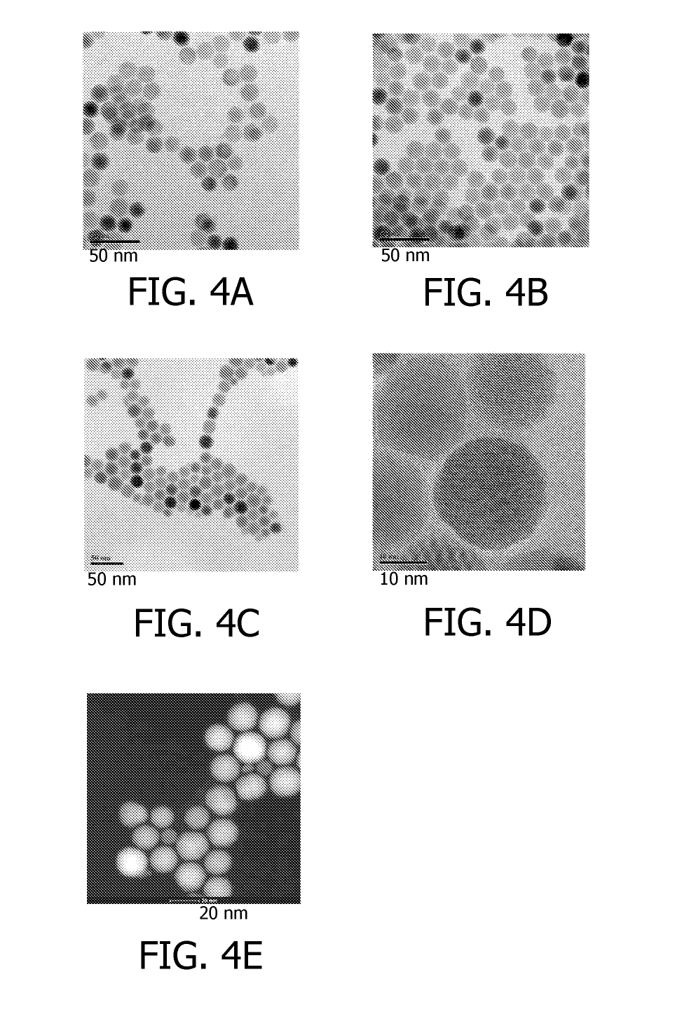

A TEM analysis was performed with samples A, B, and C. As can be derived from FIG. 4, the MPS signal improved from sample A (see FIG. 4A) to sample B (see FIG. 4B). However, the TEM images of the samples show no significant differences in the morphologies of the nanoparticles. Both, samples A and B contained monodisperse particles and had a similar average diameter of 16.3±1.7 nm (sample A) and 16.7±1.1 nm (sample B). For sample C (see FIG. 4 C) which showed the highest MPS signal in this sequence, particle with faceted cores were found (see FIG. 4 D). Furthermore, it was observed that this sample showed a broader size distribution (average diameter: 18.0±3.5 nm) than samples A and B. Therefore, a further improved MPS performance is expected upon fractionation of this non monodisperse sample.

### X-Ray Diffractometry (XRD):

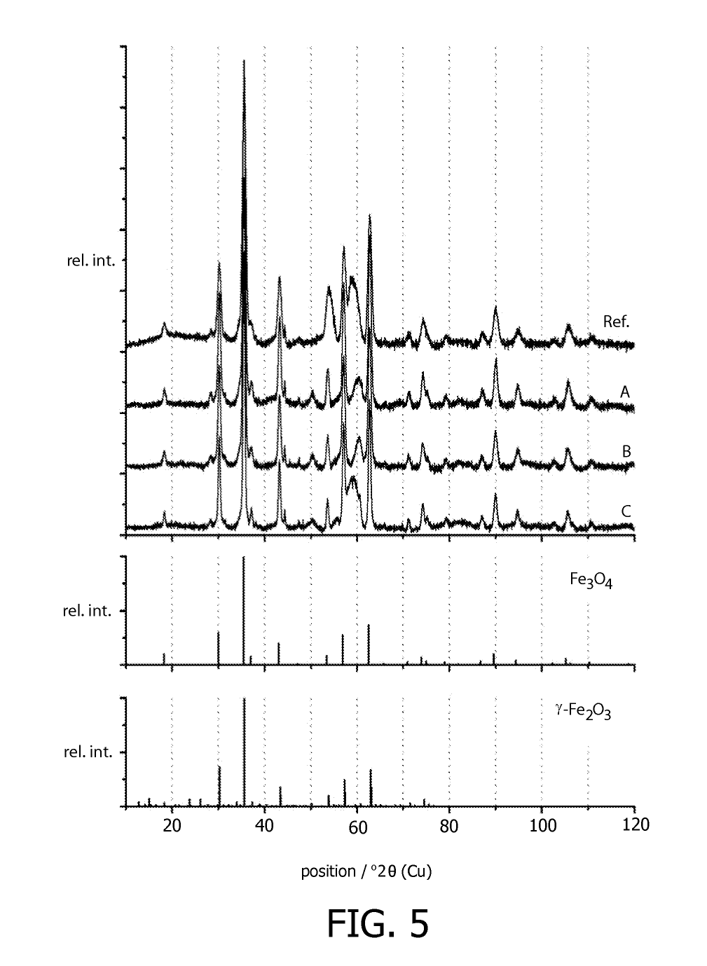

XRD is a very sensitive technique for the analysis of the crystal structure of iron oxide particles and therefore a powerful tool in order to distinguish between different types of iron oxide materials. Samples A, B, and C were studied by XRD and the obtained spectra were compared with theoretical diffraction patterns as well as an Fe₃O₄ reference sample (see FIG. 5). Based on this analysis, all tested samples (A, B, and C) were identified to comprise mainly Fe₃O₄ iron oxide cores.

### Vibrating Scanning Magnetometry (VSM):

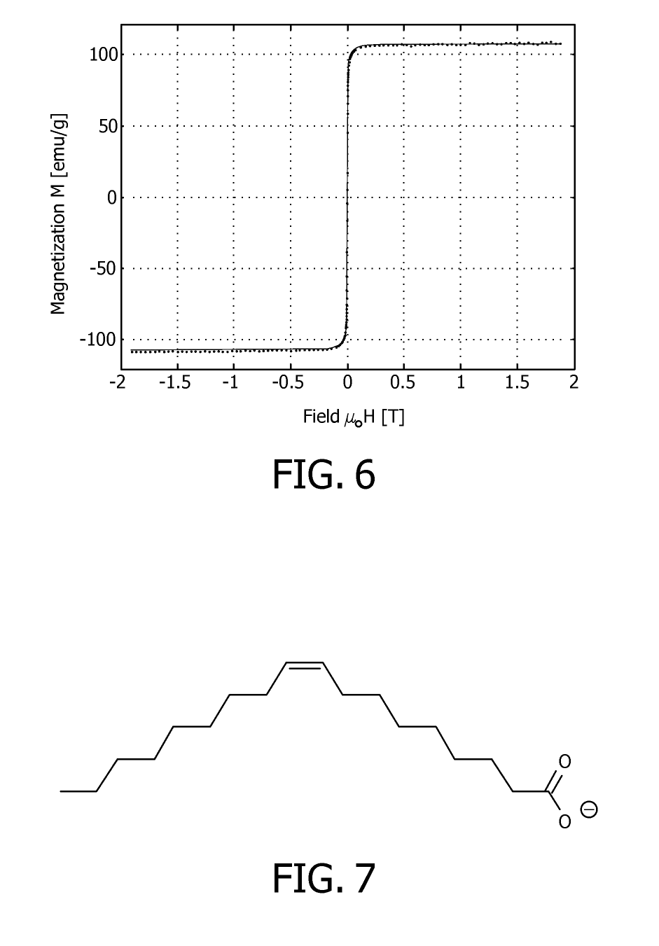

A high non-linearity of the magnetization curve of the nanoparticle tracer materials is essential for a good MPS performance. The result of a vibrating scanning magnetometry analysis of sample C is shown in FIG. 6. As can be derived from FIG. 6 the sample shows a very sharp remagnetization curve as well as a high saturation magnetization of 107 emu/g, which is consistent with a description of the magnetic core as Fe₃O₄.

1. A method of forming iron oxide nanoparticles comprising the steps of:
(a) suspending iron oxide/hydroxide and oleic acid or a derivative thereof in a primary organic solvent;
(b) increasing the temperature of the suspension by a defined rate up to a maximum of 340° C. to 500° C.;
(c) aging the suspension at the maximum temperature of step (b) for about 0.5 to 6 h;
(d) cooling the suspension;
(e) adding a secondary organic solvent;
(f) precipitating nanoparticles by adding a non-solvent and removing excess solvent;
(g) dispersing said nanoparticles in said secondary organic solvent;
(h) mixing the dispersion of step (g) with a solution of a polymer or with a hydrophilic or amphiphilic stabilizer such as citric acid, tartaric acid lactic acid, oxalic acid, and/or any salt thereof, a dextran, carboxydextran, a polyethylenoxide-based polymer or co-polymer, or any combination thereof; and
(i) optionally removing said secondary organic solvent.

2. The method of claim 1, wherein said iron oxide/hydroxide is iron(III) oxide/hydroxide, iron(II) oxide/hydroxide or a mixture of iron(III) and iron(II) oxide/hydroxide.

3. The method of claim 1, wherein said derivative of oleic acid is ammonium oleate, lithium oleate, sodium oleate, potassium oleate, magnesium oleate, calcium oleate, aluminum oleate or iron oleate.

4. The method of claim 3, wherein said ammonium oleate is an alkyl ammonium oleate having the formula R¹R²R³R⁴N⁺, wherein R¹, R², R³ and R⁴ is an alkyl, aryl or silyl group, or a hydrogen.

5. The method of claim 4, wherein said alkyl ammonium oleate is tetramethylammonium oleate, tetraethylammonium oleate, tetrapropylammonium oleate, tetrabutylammonium oleate or benzylammonium oleate.

6. The method of claim 1, wherein said primary organic solvent is an alkane solvent having the formula CₙH₂ₙ₊ₘ, with 15≦n≦30 and −2≦m≦2; and/or said non-solvent is acetone, butanone, pentanone, isopropylmethylketon, diethylester, methylpropylether, methylisopropylether, ethylpropylether, or ethylisopropylether; and/or said secondary organic solvent is pentane, isopentane, neopentane, hexane, heptane, dichloromethan, chloroform, trachloromethan or dichloroethane.

7. The method of claim 1, wherein said rate of the temperature increase of step (b) is between about 1° C. and 10° C. per minute.

8. The method of claim 1, wherein said temperature maximum of step (b) is 340° C. to 400° C. and/or wherein said temperature of the suspension in cooling step (d) is lowered to about 40° C. to 90° C.

9. The method of claim 1, wherein said aging of step (c) is carried out for about 1 to 5 h.

10. The method of claim 1, wherein said solution of a polymer is an essentially aqueous buffer solution of a hydrophilic biocompatible copolymer comprising poly ethylene glycol (PEG) and/or poly propylene glycol (PPG), an essentially aqueous solution of an amphiphilic phospholipid comprising poly ethylene glycol (PEG) or an essentially aqueous buffer solution of an amphiphilic block-copolymer.

11. (canceled)

12. The method of claim 1, wherein said removing step (i) is carried out by stirring the mixture in an essentially non-closed system thereby allowing evaporation of said secondary organic solvent until an aqueous solution of hydrophilic nanoparticles is obtained.

13. The method of claim 1, wherein one or more of the additional steps
(j) purifying the nanoparticle or nanoparticle solution obtainable in step (i);
(k) treating the nanonparticle or nanoparticle solution obtainable in step (i) or (j) with an oxidizing or reducing agent;
(l) modifying the surface of the nanoparticle obtainable in step (i), (j), or (k) by removing, replacing or altering the polymer or stabilizer coating;
(m) encapsulating or clustering the nanoparticle obtainable in step (i) to (l) with a carrier such as a micelle, liposomes, polymersomes, a blood cell, a polymer capsule, a dendrimer, a polymer, or a hydrogel; and
(n) decorating the nanoparticle obtainable in step (i) to (m) with a specific targeting ligand,
is performed.

14. An iron oxide nanoparticle obtainable by a method according to claim 1.

15. Use of the iron oxide nanoparticle of claim 14 as a tracer for Magnetic Particle Imaging (MPI) or Magnetic Particle Spectroscopy (MPS).
